(19) United States
(12) Patent Application Publication
(10) Pub. No.: US 2009/0285067 A1
(43) Pub. Date: Nov. 19, 2009

(54) BACK-UP METHOD FOR DEFECTIVE DATA

(76) Inventors: Shih-Kuo Chen, Taoyuan County (TW); Chin-Fa Hsu, Taoyuan County (TW); Shiu-Ming Chu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/403,352

(22) Filed: Mar. 12, 2009

(30) Foreign Application Priority Data
May 15, 2008 (TW) 097118286

(51) Int. Cl. G11B 20/18

(52) U.S. Cl. 369/53.17; G9B/20.046

(57) ABSTRACT

A back-up method for defective data includes: first writing a batch of data clusters on a user data area; reading the data clusters to check for defects; planning back-up positions on the back-up area; writing the correct data for the defective data clusters to form a batch of corresponding replacing blocks; reading the replacing blocks to check defects; planning back-up positions on the back-up area; and writing the correct data for the batch of replacing blocks in order until the rewritten replacing blocks do not contain defects.

### BACKGROUND OF THE INVENTION

1. Field of the Invention

The present invention relates to a data backup method, and more particularly, to a method for backing up correct data for data that are verified as defective when writing to an optical disc.

2. Description of the Prior Art

Since optical disc drives use tiny and concentrated marks to increase storage capacity, stains, dust or scratches can entirely cover these marks and affect the accuracy of reading. Optical disc drives provide defect management mechanisms such that data in defect areas can be stored in replacement areas on the optical disc. When an optical disc drive reads data from the optical disc, replacement data is substituted for the defect data and thus the optical disc can be read smoothly.

Please refer to FIG. 1(a) in conjunction with FIG. 1(b) and FIG. 1(c), FIGS. 1(a), (b) and (c) illustrate an access process of a defective data backup of an optical disc 10 in the prior art. As shown in FIG. 1(a), from an inner track to an outer track, the optical disc 10 is divided into a lead-in area 11, a first backup area 12, a user data area 13, a second backup area 14 and a lead-out area 15, respectively. When an optical disc drive control unit 16 receives an instruction from a server to write data, the optical disc drive control unit 16 receives data which is to be written and stores the data in a buffer memory area 17 in a memory. A cache memory area 18 is further allocated in the memory and a pick-up head 19 is moved to write data clusters 1-5 in the user data area 13 sequentially. Then, the just written data clusters 1-5 are read and it is verified whether or not there are any defective data within. If no defective data is found, a next batch of data clusters are processed; if defective data is found, backup locations for the defective data clusters are allocated: e.g., data clusters 2, 3, 4 indicated by slash marks in FIGS. 1(a), (b), and (c), are moved to a backup area, e.g. the backup area 12 in FIGS. 1(a), (b), and (c), thereby the correct data clusters 2, 3 and 4 in the buffer memory area 17 are written sequentially in replacement blocks a, b and c as backup data.

As shown in FIG. 1(b), after the backup data are written, the batch of data clusters in the replacement blocks a, b, and c are read again and it is verified whether or not there is any defective data. If no defective data is found, with next batch of data clusters is processed; if defective data is found in the replacement blocks a and c, i.e. data in the replacement blocks a and c are defective backup data, backup locations immediately after the replacement blocks a, b, and c are allocated, and the correct data in the data cluster 2, 4 is written again directly in replacement blocks d, e as backup data. Data in the newly written replacement blocks are repeatedly read and verified until there is no defective data and the data in the replacement blocks are valid for backup data. Then, the addresses of all the defective data clusters 2, 3, 4 and the addresses of all the corresponding effective replacement blocks d, b, e in the first backup area 12 in the defect management list in the lead-in area 11 of the optical disc 10 are registered, and thereby with next batch of data clusters can be processed.

As shown in FIG. 1(c), phases (1)-(9) illustrate the action flow of pick-up head 19, wherein the solid lines indicate that the pick-up head 19 executes a reading process and the dotted lines indicate that the pick-up head 19 only moves without any other action. When the optical disc drive control unit 16 receives an instruction from a server to read data clusters 1-5 in the optical disc 10, the optical disc drive control unit 16 moves the pick-up head 19 to the user data area 13 in phase (1) to search for locations of required data and read the required data cluster 1 sequentially. Once the defective data cluster 2 is encountered, the action flow enters phase (2), to check if there is replacement block d corresponding to data cluster 2 in the cache memory area 18. If yes, data in the replacement block d is read directly; otherwise, the pick-up head 19 is moved to the replacement block d in the first backup area 12 according to the corresponding address registered in the defect management list to read data in the replacement block d to replace defective data cluster 2; meanwhile, as the pick-up head 19 moves to the replacement block d, it also reads data in the following replacement blocks to the cache memory area 18 as cache data, i.e., the pick-up head 19 reads data in the replacement block e to the cache memory area 18 as cache data. In phase (4), the pick-up head 19 moves back to the user data area 13 to read the data cluster 3. In phase (5), since the data cluster 3 is a defective data cluster, the pick-up head 19 checks the cache memory area 18 of the optical disc drive. When there is no replacement block b for the data cluster 3, the pick-up head 19 moves back to the effective replacement block b for the data cluster 3 in the first backup area 12 according to the defective management list. In phase (6), the data in the replacement block b is read to replace defective data cluster 3. In phase (7), the pick-up head 19 moves back to the data cluster 4 in the user data area 13. Finally, in phase (8), although the data cluster 4 is defective, the data in the replacement block e (the correct data in the data cluster 4) was read in the cache memory area 18 in phase (3) and can be cached to read and replace the defective data; therefore, the data cluster 5 can be processed. The process of reading the required data is finished.

In the process of accessing backup data of defective data in the prior art, however, the sequence of the replacement blocks in the replacement area fails to coincide with the sequence of the data clusters in the user data area due to multiple times of reading and verifying. As a result, when reading some specific replacement blocks in the backup area, the pick-up head which moves according to the sequence cannot read a replacement block that is located at a leading address but allocated at a lagging sequence. The optical disc drive has to move the pick-up head 19 back and forth between the user data area and the backup area, performing track jumping and track locking repeatedly, leading to an elongated time required for reading and negatively affecting the overall performance of the optical disc drive. Therefore, there are still issues to be solved in the writing sequence in the backup area in the conventional method of defective data backup for optical disc.

### SUMMARY OF THE INVENTION

A primary objective of the present invention is to provide a defective data backup method that writes data in replacement blocks in sequence in the backup area to facilitate reading the data in the replacement blocks as cache data, leading to a reduction of the time to move the pick-up head when reading data and thus enhancing reading efficiency.

Another objective of the present invention is to provide a defective data backup method for utilizing effective replacement blocks in the backup area repeatedly and writing data in the replacement blocks in sequence once again to save space in the backup area.

To achieve the aforementioned objectives, a batch of data clusters are written in the user data area first, and then the batch of data clusters are read and verified for checking any existing defects. If a defect is found, a space in the backup area is allocated for writing correct data in sequence in place of the defective data cluster to form a batch of replacement blocks, and the data in the replacement blocks are read and verified for checking any existing defect. If a defect is still found in the batch of the replacement blocks, another space in the backup area is allocated for writing correct data in sequence in place of the defective data in the other replacement cluster to form another batch of replacement blocks until there is no defect in the rewritten data in the replacement cluster in the backup area, thereby maintaining the sequence of the replacement cluster to facilitate reading them as cache data.

In the present invention, the allocated space in the backup area is continuous, and the defective data cluster in the batch is rewritten in the space immediately after the batch of the replacement blocks. When allocating spaces in the backup area, defective replacement blocks are skipped, effective replacement blocks within the batch of replacement blocks are utilized and the backup area following the batch of the replacement blocks is sequentially rewritten with defective data clusters in the batch of data clusters for the sake of saving space in the backup area. Before finishing the writing process, it is checked if the writing process of the data clusters that need to be written are finished or not; if the process is not finished, a next batch of data clusters can be processed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1(a), (b) and (c) are diagrams illustrating an access process of defective data backup according to the prior art.

FIGS. 2(a) and (b) are diagrams illustrating a backup process of data according to a first embodiment of the present invention.

FIG. 3 is a flowchart of a defective data backup method according to a first embodiment of the present invention.

FIG. 4 is a diagram illustrating a reading process of defective data backup according to the first embodiment of the present invention.

FIGS. 5(a) and (b) are diagrams illustrating a backup process of data according to a second embodiment of the present invention.

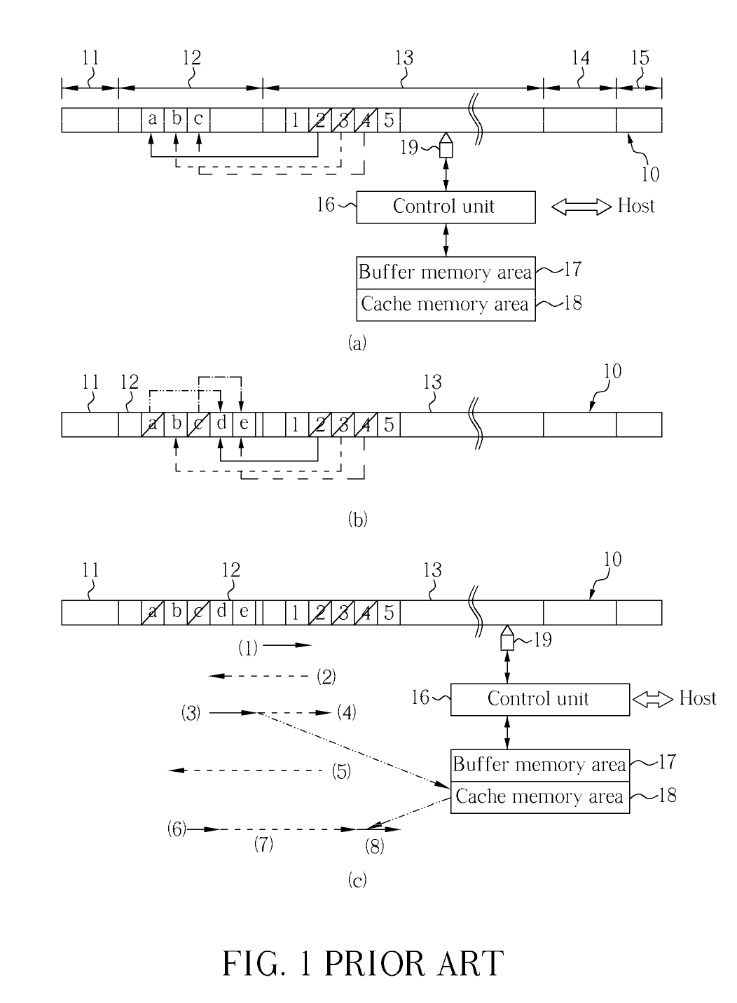

### DETAILED DESCRIPTION

To accomplish the aforementioned objectives, a preferred embodiment of the technique according to the present invention is addressed in conjunction with illustrations in the following paragraphs.

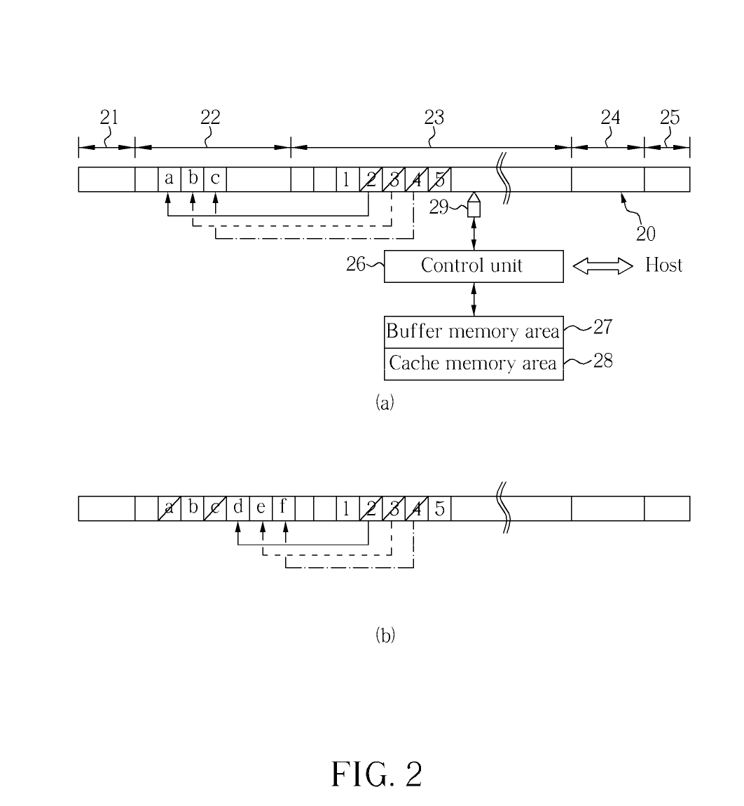

Please refer to FIGS. 2(a) and (b). FIGS. 2(a) and (b) illustrate the process of defective data backup according to a first embodiment of the present invention. As shown in FIG. 2(a), from an inner track to an outer track, a write-once/rewritable optical disc 20 is divided into a lead-in area 21, a first backup area 22, a user data area 23, a second backup area 24 and a lead-out area 25, respectively. When a control unit 26 receives an instruction from a server to write data, the control unit 26 receives data which is to be written and stores the data in the buffer memory area 27 in a memory which further includes a cache memory area 28. The pick-up head 29 moves in sequence to write data received from the buffer memory area 27 in the user data area 23 as a batch of data clusters 1-5. The batch of data clusters 1-5 are then read and verified to determine if there is any defect within. If a defect is found, successive backup locations in the backup areas are allocated for the defective data clusters, e.g., data clusters 2, 3, and 4 indicated by slash marks in FIGS. 2(a) and (b). The sequence of the address of the data clusters 2, 3 and 4 in the user data area 23 is followed to write correct data clusters 2, 3 and 4, respectively, to form a batch of replacement blocks a, b and c as backup.

As shown in FIG. 2(b), the written batch of replacement blocks a, b and c are read and verified to check if there is any defect within. If a defect is found, e.g., the replacement blocks a, c are defective, further backup locations in the backup area are allocated since the defective replacement blocks a, c might be damaged and can no longer be used. The correct batch of defective data clusters 2, 3 and 4 are rewritten in sequence in the successive backup locations allocated after the batch of the replacement blocks a, b and c to form another batch of replacement blocks d, e and f. The steps of reading, verifying, and writing data in the replacement blocks are repeated until the batch of defective data clusters 2, 3 and 4 is stored in the replacement blocks in the backup area effectively and sequentially. Assuming that in this embodiment, the data in the replacement blocks d, e and f are verified to have no defect within, thereby the defective data clusters 2, 3, 4 and the addresses of the corresponding replacement blocks d, e, f will be registered in the defect management list (not shown in FIGS. 2(a) and (b)), then a next batch of data can be processed until all data which needs to be written are processed.

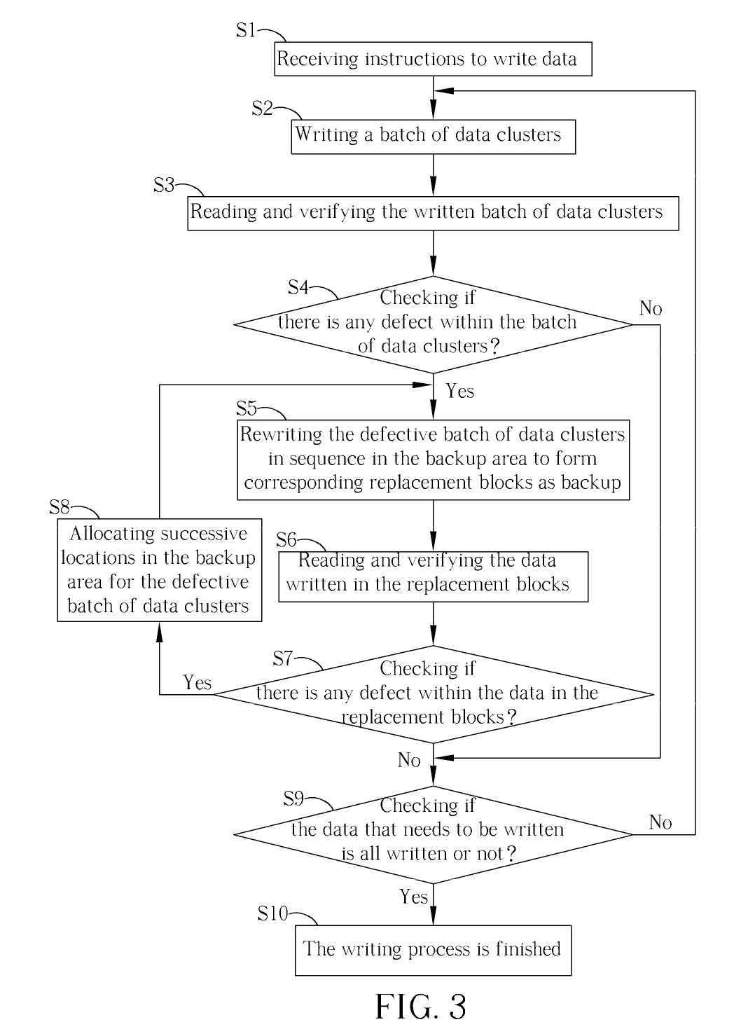

FIG. 3 is a flowchart illustrating the first embodiment of the method of defective data backup according to the present invention. In step S1, when receiving instructions from the server to write data, data which needs to be written is received. In step S2, the received batch of data is written in the user data area. In step S3, the written batch of data clusters are read and verified. In step S4, it is checked if there is any defect within the batch of data clusters which are just written. If no, the process proceeds to step S9: otherwise, it proceeds to step S5. In step S5, the defective batch of data clusters is rewritten in sequence in successively allocated locations in the backup area to form corresponding replacement blocks as backup.

Next in step S6, data written in the replacement blocks are read and verified. In step S7, it is checked if there is any defect within the data in the replacement blocks. If no, the process proceeds to step S9; otherwise, it proceeds to step S8. In step S8, successive locations in the backup area for the defective batch of data clusters are allocated and then the process goes back to step S5. In Step S9, it is checked if the data that needs to be written is all written or not. If no, the process goes back to step D2; otherwise, it proceeds to step S10. In step S10, the writing process is finished.

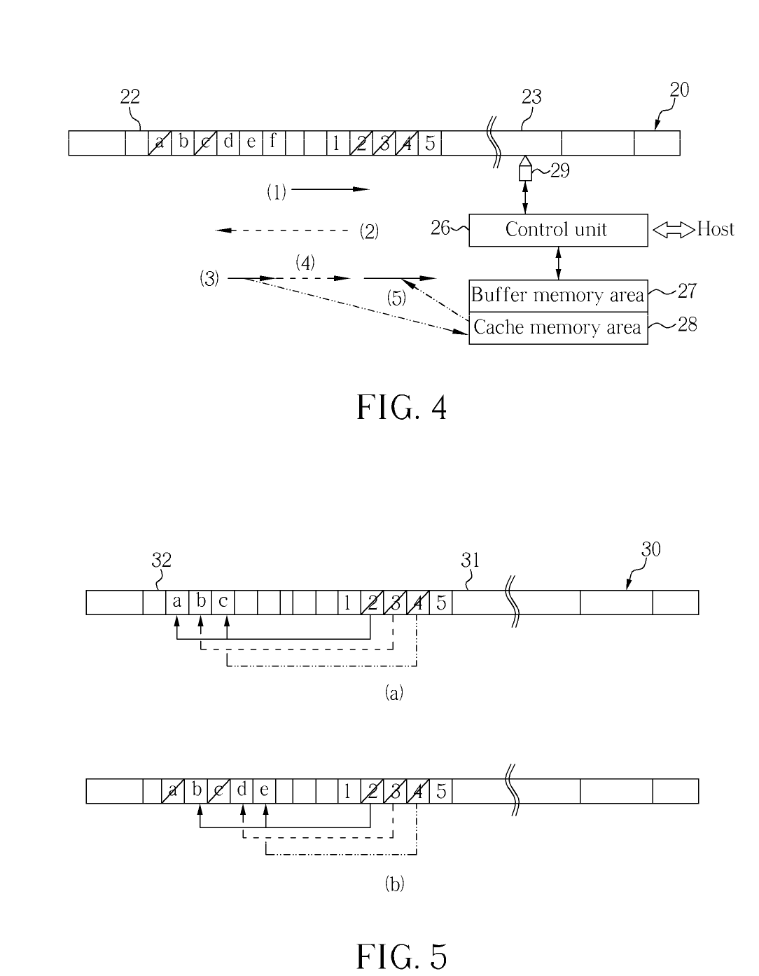

FIG. 4 is a diagram illustrating a reading process of defective data backup in an optical disc when the defective data backup is finished according to the present invention. As shown in FIG. 4, phases (1)-(5) illustrate the action flow of the pick-up head 29, wherein the solid lines indicate that the pick-up head 29 executes a reading process and the dotted lines indicate that the pick-up head 29 only moves without any other action. When the optical disc drive control unit 26 receives an instruction from a server to read data clusters 1-5 in the optical disc 20, the optical disc drive control unit 26 moves the pick-up head 29 to the user data area 23 in phase (1) to search for locations of required data and read the required data cluster 1 sequentially. Once the defective data cluster 2 is encountered, the action flow enters phase (2), it is checked if there is replacement block d corresponding to data cluster 2 in the cache memory area 28, and the pick-up head 29 is moved to the replacement block d in the first backup area 22. In phase (3), data in the replacement block d is read to replace defective data cluster 2 as cache data. In phase (4), the pick-up head 29 is moved back to data cluster 3 to read data. In phase (5), since the data cluster 3 is defective, the cache area 28 of the optical disc drive is checked first. Since cache data includes replacement block e corresponding to the data cluster 3 and replacement block f corresponding to the data cluster 4, the defective data clusters 3 and 4 are replaced by the data in the replacement block e and f to finish the reading process quickly.

Therefore, the first embodiment of the defective data backup method according to the present invention is capable of writing data in replacement blocks in sequence corresponding to the sequence of the data cluster in a user data area for defective data clusters as backup. When reading user data area, a defective data cluster in a prior sequence is read first, leading to read a replacement block of the prior sequence in the backup area to facilitate the pick-up head to read data in a replacement block in a posterior sequence to the cache memory area as cache data. In this way, when encountering defective data clusters in the posterior sequence, the pick-up head does not have to move to the backup area again but can read the replacement blocks corresponding to the defective data cluster directly. Therefore, the pick-up head does not have to move back and forth often, meaning a reading time can be shortened and thus a reading efficiency can be improved.

FIGS. 5(a) and (b) illustrate a defective data backup method according to a second embodiment of the present invention. The process flow of the second embodiment is largely the same as the first embodiment; the difference is the locations of the replacement blocks allocated in the backup area for rewriting. As shown in FIG. 5(a), it is assumed that, in this embodiment, the data clusters 1-5 are written in a user data area 31 in a rewritable optical disc 30, wherein the data clusters 2, 3, 4 are verified as defective and replacement blocks a, b, c are rewritten in a backup area 32 in sequence to form corresponding backup, respectively. As shown in FIG. 5(b), if the replacement blocks a, c are still verified as defective, the replacement blocks a, c might be damaged whereas the replacement block b is still writable. When further allocating backup locations in the backup area, invalid replacement blocks a and c are skipped and effective replacement block b and effective locations after the batch of the replacement blocks in the backup area are utilized to allocate successive backup locations for the batch of defective data clusters 2, 3, 4. Correct data clusters are rewritten in sequence and successive backup locations are allocated in the backup area to form replacement blocks b, d, e corresponding to data clusters 2, 3, 4 in a corresponding sequence such that the replacement blocks b, d, e can be read as cache data in sequence.

Therefore, the defective data backup method corresponding to the second embodiment of the present invention not only can achieve writing of data in sequence in replacement blocks in the backup area for the data cache, but can also further utilize the rewritable characteristic of an optical disc to use effective replacement blocks repeatedly. Only part of the effective locations in the backup area are required as replacement blocks are rewritten in sequence, therefore space in the backup area can be saved.

Those skilled in the art will readily observe that numerous modifications and alterations of the device and method may be made while retaining the teachings of the invention.

What is claimed is:

1. A defective data backup method, for writing to an optical disc, and forming a backup replacement block in a backup area of the optical disc corresponding to a defective data cluster generated in a user data area in the optical disc, comprises:
(1) writing a batch of data clusters in the user data area;
(2) reading and verifying the written batch of data clusters to check whether there is any defect within the batch of data clusters; If no defect is found, go to step (6); if there is a defect found, go to step (3);
(3) allocating locations in the backup area and writing correct data for the defective clusters within the batch of data clusters to form a corresponding batch of replacement blocks,;
(4) reading and verifying the written batch of replacement blocks to check whether there is any defect within the batch of replacement blocks; and
(5) allocating locations for backup of the batch of replacement blocks, then going back to step (3);
(6) finishing writing process.

2. The defective data backup method of claim 1, wherein the step (3) rewrites data according to the sequence of the addresses of the defective data clusters in the user data area.

3. The defective data backup method of claim 1, wherein the step (5) allocates the locations successively.

4. The defective data backup method of claim 3, wherein the allocated locations for backup are immediately after the batch of the replacement blocks.

5. The defective data backup method of claim 4, wherein the backup method is also applicable to a writable optical disc.

6. The defective data backup method of claim 3, wherein the allocating of the locations for backup skips defective replacement blocks.

7. The defective data backup method of claim 6, wherein the allocating of the locations for backup utilizes effective replacement blocks within the batch of the replacement blocks and the effective locations are immediately after the batch of the replacement blocks in the backup area.

8. The defective data backup method of claim 7, wherein the backup method is also applicable to a rewritable optical disc.

9. The defective data backup method of claim 1, wherein before the writing process is finished, the step (6) further checks whether the writing of data clusters that need to be written are finished or not. If the writing is not finished, go back to step (1) to write next batch of data clusters; if the writing is finished, finish the writing process.
